(19) United States
(12) Patent Application Publication
(10) Pub. No.: US 2004/0045577 A1
(43) Pub. Date: Mar. 11, 2004

(54) Cleaning of processing chambers with dilute NF3 plasmas

(76) Inventors: Bing Ji, Allentown, PA (US); James Hsu-Kuang Yang, Allentown, PA (US); Delwin L. Elder, Allentown, PA (US); Eugene Joseph Karwacki JR., Orefield, PA (US)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 10/238,803

(22) Filed: Sep. 10, 2002

(51) Int. Cl. B08B 6/00

(52) U.S. Cl. 134/1.1

(57) ABSTRACT

Method for removing deposited material from the interior surfaces of a processing chamber. The method comprises introducing a gas mixture comprising less than 15 mole % nitrogen trifluoride in a diluent gas into a processing chamber having deposited material on the internal surfaces thereof, establishing a plasma in the processing chamber utilizing a radio frequency power density of greater than 1.4 W/cm² and forming chemically reactive fluorine-containing species therein, reacting the deposited material with the chemically reactive fluorine-containing species to yield volatile reaction products, and removing the volatile reaction products from the processing chamber.

### BACKGROUND OF THE INVENTION

In the manufacture of semiconductor integrated circuits (IC), opto-electronic devices, flat panel display (FPD) devices, and microelectro-mechanical systems (MEMS), multiple layers of thin films are deposited in order to construct several complete circuits (chips) and devices on monolithic substrate wafers. Each wafer often is deposited with a variety of thin films. Thin film deposition is accomplished by placing a substrate in a vacuum chamber and introducing gases that undergo chemical reactions to deposit solid materials onto internal surfaces (including the substrate surface). This deposition process is called chemical vapor deposition (CVD).

The CVD chemical reactions often require elevated temperatures (up to 600° C.) to overcome reaction activation energies. Alternatively, radio frequency (RF) energies are coupled into the process to ignite the precursors into a discharge state, i.e., a plasma. This process is termed plasma enhanced chemical vapor deposition (PECVD). When using plasmas as the energy sources, faster and better films can be deposited quickly at lower process temperatures compared with other deposition processes.

In addition to depositing films onto the substrate, the process also leaves films and solid residues on the internal surfaces throughout the deposition reactor. These unwanted solid residues can change the reactor surface characteristics and the RF power coupling efficiency in forming the plasma in the reactor. Such reactor changes can lead to deposition process performance drifts and loss of production yield. In addition, accumulated solid residues can flake off the deposition reactor internal surface and deposit particles on the wafer surface, which can cause device defects and loss of production yield.

Periodic cleaning of the internal surfaces of the deposition reactor, often called chamber cleaning, is necessary to maintain production yield. For CVD reactors, chamber cleaning is carried out by utilizing fluorine chemistry to convert solid residues into volatile gaseous byproducts that can be pumped out of the reactor by vacuum pumps. For example, reactive fluorine atoms are used to convert tungsten and silicon-containing solid materials into gaseous WF₆ and SiF₄ during chamber cleaning. Reactive fluorine atoms are generated from fluoro-compounds, which can be dissociated by either thermal activation or plasma activation to release reactive fluorine species. There are two ways to achieve plasma activation—a remote plasma clean and an in situ plasma clean. In a remote plasma clean, the plasma chamber is outside of the CVD reactor. The reactive fluorine species then flow downstream to the CVD chamber to carry out the cleaning reactions. In an in situ plasma clean, fluoro-compound plasmas are generated inside the same CVD reactor.

Because a CVD reactor is designed for optimal performance of deposition processes, optimizing in situ chamber cleaning plasmas may be technically challenging. A large number of CVD reactors in the industry utilize in situ plasma chamber cleaning methods.

Historically, perfluorocarbons such as CF₄ and C₂F₆, have been used as the source of reactive fluorine in chamber cleaning. High-energy electrons in plasmas collide with and dissociate perfluorocarbon molecules to form reactive fluorine-containing species such as C₂F₅., C₂F₄., CF₃., CF₂., CF., and F..

However, recombination reactions also occur at the same time, which removes reactive fluorine species from the plasma and reduces the reaction of these species with solid residues on the interior of the reactor. Further recombination of fluorocarbon radicals can form polymeric films on the internal surfaces of the reactor.

The formation of polymeric films on the internal surfaces of CVD reactors is undesirable since it leads to production yield loss. To reduce the extent of recombination, an oxidizing gas, such as O₂ and/or N₂O, may be added into the plasma. Despite the addition of an oxidizing gas, some degree of recombination is inevitable in fluorocarbon gas based plasmas. As a result, all fluorocarbon gas based in situ chamber clean processes emit significant amounts of CF₄ into the plasma effluent stream. Unfortunately, atmospheric emissions which occur when using perfluorocarbon gases for chamber cleaning have an adverse impact on the environment. Perfluorocarbons, such as CF₄ and C₂F₆, strongly absorb infrared radiation and have very long atmospheric lifetimes—more than 50,000 years for CF₄ and 10,000 years for C₂F₆. These perfluorocarbon gases are the most potent greenhouse gases contributing to global warming.

Since perfluorocarbon molecules are very stable, they are difficult to dissociate in plasmas, hence perfluorocarbon destruction efficiency tends to be very low. Typical destruction efficiency is only 5 to 20% for CF₄ and 20 to 50% for C₂F₆. In addition to undestroyed or unreacted perfluorocarbon feed gases, perfluorocarbon-based cleaning processes emit significant amounts of recombined CF₄ as noted above. Although estimates vary somewhat, it is generally agreed that up to 70% of the perfluorocarbon emissions from a semiconductor fabrication facility comes from CVD chamber cleaning processes. With the exponential growth of the semiconductor industry, the perfluorocarbons emitted from semiconductor manufacturing processes could become a significant source of global warming emissions.

Replacing perfluorocarbons with nitrogen trifluoride (NF₃) for CVD chamber cleaning offers a dramatic improvement in reducing greenhouse gas emissions. NF₃ has a much shorter atmospheric lifetime—only about 750 years—and unlike most of the perfluorocarbons, NF₃ readily dissociates in plasmas. The large amount of fluorine atoms generated in NF₃ plasmas can greatly enhance chamber cleaning reactions. When fully optimized, the destruction efficiency for NF₃ in an in situ cleaning process can be above 90%. Since NF₃ does not contain carbon, no CF₄ is emitted from NF₃ plasmas, and no global warming byproducts can be formed in NF₃ plasmas. Therefore, significant reductions in greenhouse gas emissions can be achieved by replacing perfluorocarbon gases partially or completely with NF₃ in CVD chamber cleaning.

In addition to environmental benefits, a fully optimized NF₃-based chamber cleaning process also offers significant production advantages by providing much faster clean time and eliminating the formation of polymeric films on the internal surfaces of CVD reactors.

While the potential benefits of NF₃-based chamber cleaning are promising, the development of a fully optimized NF₃ in situ plasma chamber cleaning process for industrial production CVD reactors has proven to be technologically challenging. Negative ions can dominate over electrons as the charge carrier in NF₃ based plasmas, making the plasmas very electronegative. Highly electronegative plasmas may become unstable or oscillating, or even collapse or contract into part of the reactor space. Unstable and/or collapsed plasmas lead to incomplete cleaning of the CVD chamber interior surfaces, low NF₃ destruction efficiency, and poor NF₃ utilization.

While various attempts have been made in the prior art to overcome these challenges, there remains a need in the industry for a fully optimized NF₃ in situ plasma chamber cleaning process. The present invention, which is described below and defined by the claims which follow, addresses this need by providing an optimized NF₃ in situ plasma chamber cleaning process which utilizes dilute mixtures of NF₃ at selected process conditions.

### BRIEF SUMMARY OF THE INVENTION

The invention relates to a method for removing deposited material from the interior surfaces of a processing chamber comprising:

(a) introducing a gas mixture comprising less than 15 mole % nitrogen trifluoride in a diluent gas into a processing chamber having deposited material on the internal surfaces thereof;

(b) establishing a plasma in the processing chamber utilizing a radio frequency power density of greater than 1.4 W/cm² and forming chemically reactive fluorine-containing species therein;

(c) reacting the deposited material with the chemically reactive fluorine-containing species to yield volatile reaction products; and

(d) removing the volatile reaction products from the processing chamber.

The diluent gas may comprise one or more components selected from the group consisting of helium, argon, nitrogen, nitrous oxide, oxygen, neon, krypton, and xenon. In one embodiment, the diluent gas is helium. The gas mixture may contain greater than 10 mole % and less than 15 mole % nitrogen trifluoride.

The flow rate of the nitrogen trifluoride portion of the gas mixture introduced into the processing chamber may be greater than 200 sccm.

The pressure in the processing chamber at any time during (a) through (d) may be greater than about 1 and less than about 10 Torr. In one embodiment, the pressure in the processing chamber at any time during (a) through (d) may be between about 3 and about 10 Torr. In another embodiment, the pressure in the processing chamber at any time during (a) through (d) may be between about 1 and about 4 Torr. In yet another embodiment, the pressure in the processing chamber may be essentially constant during (a) through (d) at a pressure between about 2.0 and about 3.5 Torr. The radio frequency power density may be between about 2.3 and about 3.5 W/cm².

The invention also relates to a method for removing deposited material from the interior surfaces of a processing chamber comprising:

(a) introducing a gas mixture comprising greater than 10 mole % and less than 15 mole % nitrogen trifluoride into a processing chamber having deposited material on the internal surfaces thereof;

(b) establishing a plasma in the processing chamber utilizing a radio frequency power density of 2.3 to 3.5 W/cm and forming chemically reactive fluorine-containing species therein;

(c) reacting the deposited material with the chemically reactive fluorine-containing species at a pressure between about 2.0 and about 3.5 Torr to yield volatile reaction products; and

(d) removing the volatile reaction products from the processing chamber.

The flow rate of the nitrogen trifluoride introduced into the processing chamber may be greater than 200 sccm. The diluent gas may comprise one or more components selected from the group consisting of helium, argon, nitrogen, nitrous oxide, oxygen, neon, krypton, and xenon. In one embodiment, the diluent gas is helium. In this embodiment, the flow rate of the nitrogen trifluoride introduced into the processing chamber may be greater than 200 sccm.

### BRIEF DESCRIPTION OF SEVERAL VIEWS OF THE DRAWINGS

FIG. 1 is a schematic diagram of an experimental apparatus for chamber cleaning optimization.

FIG. 2 is a process flow sequence for optimizing NF₃ in situ chamber cleaning.

FIG. 3 is a plot of signal intensity vs time using optical emission spectroscopy which illustrates how to determine the endpoint of a chamber cleaning process.

FIG. 4 is a response surface of clean time vs. NF₃ flow rate and NF₃ mole %.

FIG. 5 is a response surface of global warming emissions (kgCE) vs. NF₃ flow rate and NF₃ mole %.

FIG. 6 is a response surface of clean time vs. NF₃ flow rate and chamber pressure.

FIG. 7 is a response surface of global warming emissions (kgCE) vs. NF₃ flow rate and chamber pressure.

FIG. 8 is a response surface of clean time vs. NF₃ mole % and chamber pressure.

FIG. 9 is a response surface of global warming emissions (kgCE) vs. NF₃ mole % and chamber pressure.

FIG. 10 is a normal plot of residues for clean time analysis using a design of experiments methodology.

FIG. 11 is a normal plot of residues for global warming emissions (kgCE) analysis using a design of experiments methodology.

FIG. 12 is a validation analysis using a design of experiments methodology showing predicted vs actual clean time.

FIG. 13 is a validation analysis using a design of experiments methodology showing predicted vs actual global warming emissions (kgCE).

FIG. 14 is bar chart comparison of clean time, global warming emissions (kgCE), and gas usage (weight basis) between a standard C₂F₆-based clean and various optimized NF₃-based cleans.

### DETAILED DESCRIPTION OF THE INVENTION

Replacing perfluorocarbons with nitrogen trifluoride (NF₃) in CVD chamber cleaning gases offers a dramatic improvement in reducing greenhouse gas emissions. NF₃ has a much shorter atmospheric lifetime than perfluorocarbons and dissociates more easily in plasmas according to the following reaction:

NF₃+e⁻→NF₂.+F.+e⁻ (1)

NF₃ also can form fragment ions via dissociative ionization as follows:

NF₃+e⁻→NF₂⁺+F.+2e⁻ (2)

These fragments can undergo further dissociation by the following reactions:

NF₂+e⁻→NF.+F.+e (3)

NF₂+e⁻→NF⁺+F.+2e⁻ (4)

The large amount of chemically reactive fluorine-containing species generated in NF₃ plasmas by equations (1) to (4) can enhance chamber cleaning reactions significantly. This is fundamentally why NF₃ is a very effective cleaning gas. When fully optimized, the destruction efficiency for NF₃ in an in situ chamber clean plasma can be above 90%. Significant reductions in greenhouse gas emissions thus can be achieved by replacing perfluorocarbon gases with NF₃ in CVD chamber cleaning processes.

In addition to these environmental benefits, a fully optimized NF₃ based chamber cleaning process also offers significant production advantages—it provides faster clean time and eliminates the formation of polymeric films on the internal surfaces of CVD reactors. However, the development of fully optimized NF₃ in situ plasma chamber cleaning processes for industrial production CVD reactors is technologically challenging. For example, NF₃ based plasmas can become very electronegative via several mechanisms:

NF₃+e⁻→NF₃⁻ (5)

F.+e⁻→F⁻ (6)

Recombination of fluorine atoms (F.) forms fluorine molecules (F₂):

F.+F.→F₂ (7)

F₂ can also form negative ions:

F₂+e⁻→F₂⁻ (8)

When negative ions dominate over electrons as the charge carrier, an NF₃ based plasma becomes electronegative. Highly electronegative plasmas may become unstable or oscillating, or even collapse/contract into part of the reactor space. Unstable and/or collapsed plasmas lead to incomplete cleaning of the CVD chamber interior surfaces, low NF₃ destruction efficiency, and poor NF₃ utilization. The optimization of NF₃ plasmas for CVD chamber cleaning must address and minimize these problems.

The invention described below includes a methodology and recipes to optimize dilute NF₃ in situ plasma chamber cleaning processes with fast clean time, low global warming emissions, low consumption and high utilization efficiency of the NF₃ in the cleaning gas mixture, and low reactor damage due to over heating and/or ion bombardment induced hardware degradation. Based on the disclosed methodology, various optimized process recipes (i.e., operating ranges) are presented to accomplish these objectives.

These optimization objectives often compete against one another. For example, conditions that offer the fastest clean time may lead to higher global warming emissions, higher NF₃ consumption, and lower NF₃ destruction efficiency. On the other hand, conditions that can yield nearly zero global warming gas emissions often result in longer clean time. There is also a competing optimization requirement for efficient simultaneous cleaning of the inner part of a CVD chamber (i.e., the showerhead and the susceptor) and the outer part of the CVD chamber (i.e., the chamber walls and other remote parts downstream of the chamber). Operating conditions, for example higher pressure, that speed up the inner-part cleaning often lead to slow or even incomplete cleaning of the outer part of the chamber.

In addition to these competing optimization requirements, as discussed earlier, an NF₃-based plasma can become unstable or even collapse due to the high electronegativity of NF₃ and due to large amounts of atomic fluorine (also very electronegative) generated from NF₃ dissociation processes. Unstable and/or collapsed plasmas adversely impact all aspects of chamber cleaning performance, and may worsen reactor hardware damage.

To solve this complex optimization problem, a systematic and statistically-validated Design-of-Experiments (DOE) approach was chosen as the optimization methodology. Helium was chosen as a representative diluent gas to assist energetic dissociation of NF₃ and to reduce sputtering-induced hardware damage. Helium ions and metastable helium atoms carry enough energy to dissociate and/or ionize NF₃ and its fragments to generate reactive fluorine species. Helium ions are very low in mass and thus result in minimal sputtering impact on reactor surfaces.

The process parameters optimized in the present invention are NF₃ flow rate, NF₃ mole %, reactor chamber pressure, and radio frequency (RF) power. A fully rotatable (alpha=1.68) central composite response surface design was used. Table 1 summarizes the parameter ranges used for the designed experiments. A total of 18 experimental data points were obtained with various combinations of these parameters.

TABLE 1
Parameter Ranges

| | | | RF Power |
|---|---|---|---|
| NF₃ Flow | mole % NF₃ | Pressure | Density |
| (sccm) | (balance helium) | (Torr) | (W/cm²) |
| 216-384 | 10.48-15.52 | 1.32-4.68 | 2.9 |

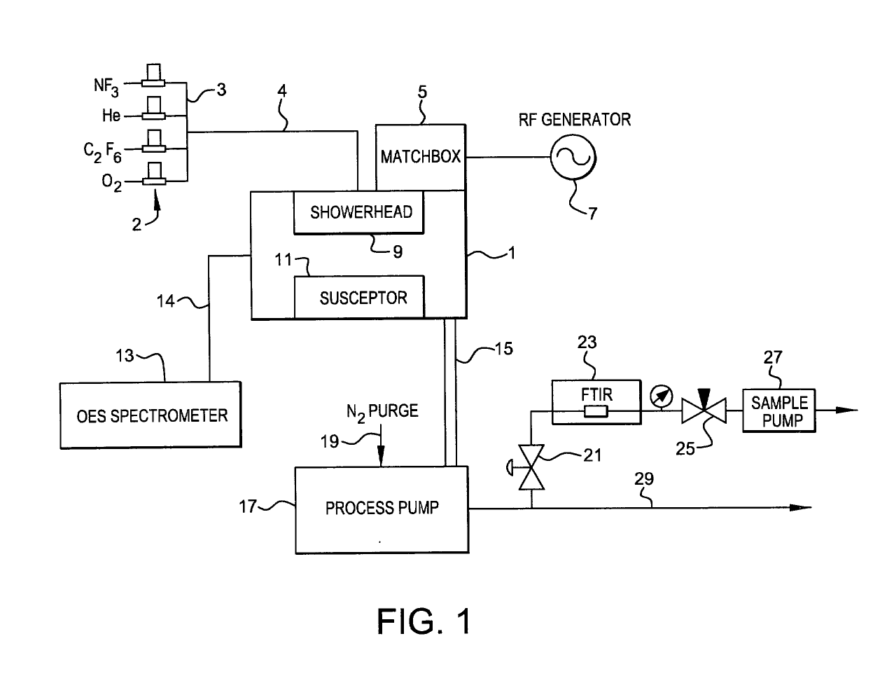

The optimization experiments were carried out in an Applied Materials (Santa Clara, Calif.) lamp-heated DxL PECVD chamber on the P-5000 platform. The DxL chamber was fitted with a 200 mm PECVD process kit. FIG. 1 shows a schematic diagram of the experiment system including CVD reaction chamber 1, mass flow controllers 2, gas supply manifold 3, gas delivery line 4, matching network or matchbox 5, RF generator 7, showerhead 9, susceptor 11, OES spectrometer system 13, vacuum pump foreline 15, process vacuum pump 17, nitrogen purge line 19, sample valve 21, Fourier Transform Infrared (FTIR) analyzer system 23, sample throttle valve 25, sample pump 27, and effluent line 29. Prior to each chamber cleaning experiment, a SiO₂ film with a thickness of about 1.0 micron was deposited onto an 8-inch silicon wafer placed on susceptor 11 using the standard Applied Materials PE-TEOS/O₂ (Plasma-Enhanced Tetraethyorthosilicate/Oxygen) deposition recipe, which is also called the Best Known Method or the TEOS BKM. The SiO₂-coated wafer was removed from CVD chamber 1 after the deposition was complete.

A cleaning gas mixture containing NF₃ and helium then was introduced via manifold 3 and line 4 into CVD chamber 1 via mass flow controllers 2 (Unit, Model 1660/1661 and 1800/1801). Once the process gas flows and chamber pressure were stabilized at the desired set points, RF generator 7 (ENI Model OEM-12B-02) was turned on and matched to the reactor via matching network 5 (Applied Materials Model 0010-09750) to ignite and sustain the plasma for chamber cleaning. The SiO₂ substrate was removed according to the reaction

SiO₂(s)+4F.→SiF₄(g)+O₂(g) (9)

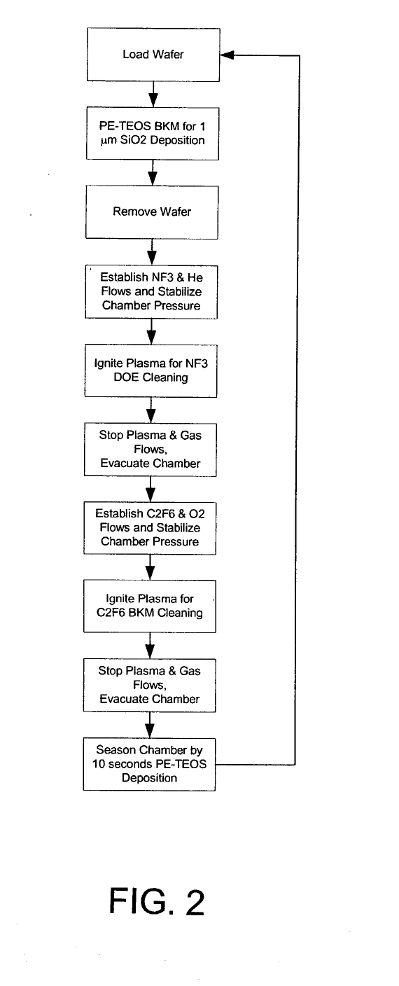

An Applied Materials standard C₂F₆/O₂ clean (also called the C₂F₆ BKM) always followed each experimental NF₃ clean to ensure that all SiO₂ residues had been removed from chamber interior surfaces. The CVD reactor electrode gap spacing was fixed at 999 mils for all the clean steps. As part of the Applied Materials C₂F₆ BKM, the chamber interior surfaces were precoated or seasoned with a thin layer of SiO₂ film after the C₂F₆/O₂ plasma clean. The seasoning step completed the sequence for one NF₃ cleaning experiment. The sequence was then repeated for the next NF₃ cleaning experiment according to the experimental design. FIG. 2 illustrates the experimental sequences for each cleaning experiment. The temperature of susceptor 11 was servo-controlled at 400° C. for both the deposition and cleaning processes.

A nitrogen purge of ˜50 standard liters per minute (slm) was added via line 19 to process pump 17 exhaust (Edwards pump, model QDP80/QMB250). The nitrogen purge flow rate was measured by flowing C₂F₆ at several flow rates through a vendor-calibrated flow meter and calculating the amount of dilution required to give the observed ppm concentration.

Fourier Transform Infrared (FTIR) absorption spectroscopy system 23 was used to analyze the gaseous emissions from the chamber clean process. A Midac spectrometer with a 1.0 cm path length cell with KBr windows was utilized. Part of the plasma effluent stream was extracted by sample pump 27 through sample valve 21 to the FTIR sample cell for analysis. A ⅛″ stainless steel sampling line leading from the pump exhaust pipeline to the spectrometer cell was heat traced at 100° C. to prevent condensation of TEOS and other siloxanes. AutoQuant 3.0 software was used to collect and process the data offline. Effluents were continuously monitored during depositions and cleans. The FTIR spectral window ranged from 650 to 4500 cm⁻¹, resolution was 4 cm⁻¹, gain was 1, triangle apodization was utilized with Mertz phase correction, and linear baseline correction was applied. To improve the signal-to-noise ratio, an average of sixty-four single beam scans was taken for the background, and an average of four single beam scans was used for each experimental data point.

Gases monitored by FTIR system 23 included NF₃ and SiF₄ for NF₃ based cleans, C₂F₆ and CF₄ for C₂F₆ based cleans, and TEOS during TEOS deposition. The endpoint for each chamber cleaning experiment was determined from fluorine signal intensity data from optical emission spectroscopy (OES) system 13, which was an Ocean Optics UV/visible spectrometer. Fiber optic cable 14, connected to the spectrometer, was mounted on the chamber's viewport window. Emission spectra were recorded approximately every 0.5 seconds during chamber cleaning. Data were analyzed off-line using the intensity of the atomic fluorine emission line at 704 nm. The atomic fluorine emission increased throughout the cleaning and leveled off when SiO₂ removal was complete.

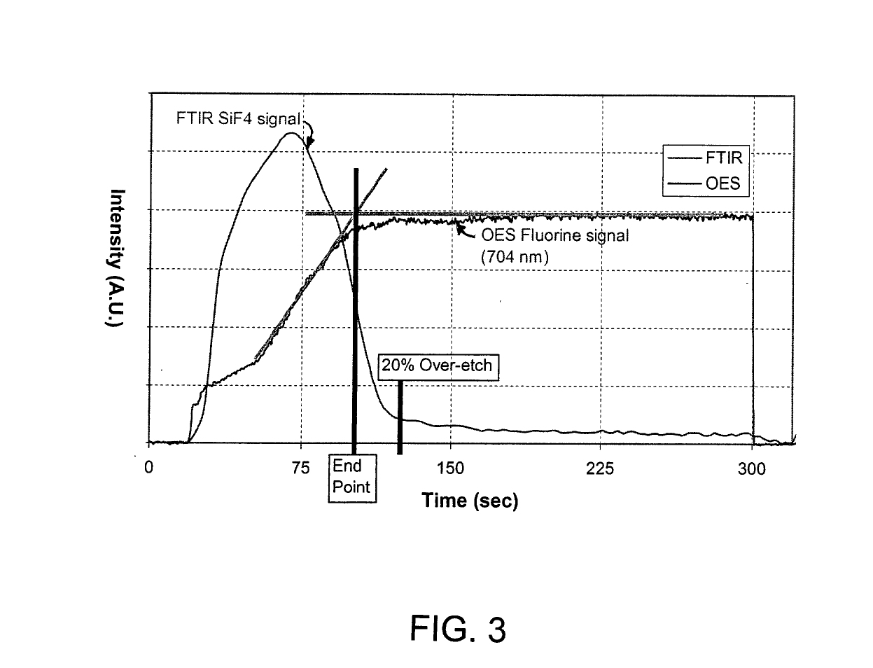

The chamber cleaning endpoint was determined by the inflection point of the atomic fluorine emission intensity as a function of time, and this endpoint was used to determine the clean time for each experiment. Clean time is defined as the interval between plasma ignition and the endpoint, where the endpoint was determined as follows. FIG. 3 shows a time plot of the OES fluorine signal and the FTIR SiF₄signal, and it is seen that the fluorine signal increases monotonically with time and eventually levels off at an asymptotic value. Straight lines drawn through the data during the monotonic increase period and through the data at the asymptote intersect at a time which defines the end point time. The volumetric emissions of each effluent gas is computed by integrating the FTIR emission profile. The FTIR data integration time is extended by 20% beyond the OES endpoint as an overetch to ensure complete removal of SiO₂.

Total global warming emissions per clean were determined in terms of kilograms of carbon equivalents (kgCE) by the following equation:

$$kgCE = {\sum }_{i} {Q}_{i} \frac{12}{44} {GWP}_{i , 100} \qquad ( 10 )$$

where Qᵢ is the amount of effluent in kilograms and GWP_{i,100} is the 100-year global warming potential of the gas. The values of GWP₁₀₀ for NF₃, CF₄, and C₂F₆ are 8000, 6500, and 9200, respectively.

The design of experiments methodology was used to determine and correlate the functional relationships between the chamber cleaning performance indicators and the process parameters by response surface analysis. The resulting relationships were plotted as three-dimensional response surfaces for the clean time and carbon equivalents as functions of the three parameters NF₃ flow rate, NF₃ mole %, and reactor pressure.

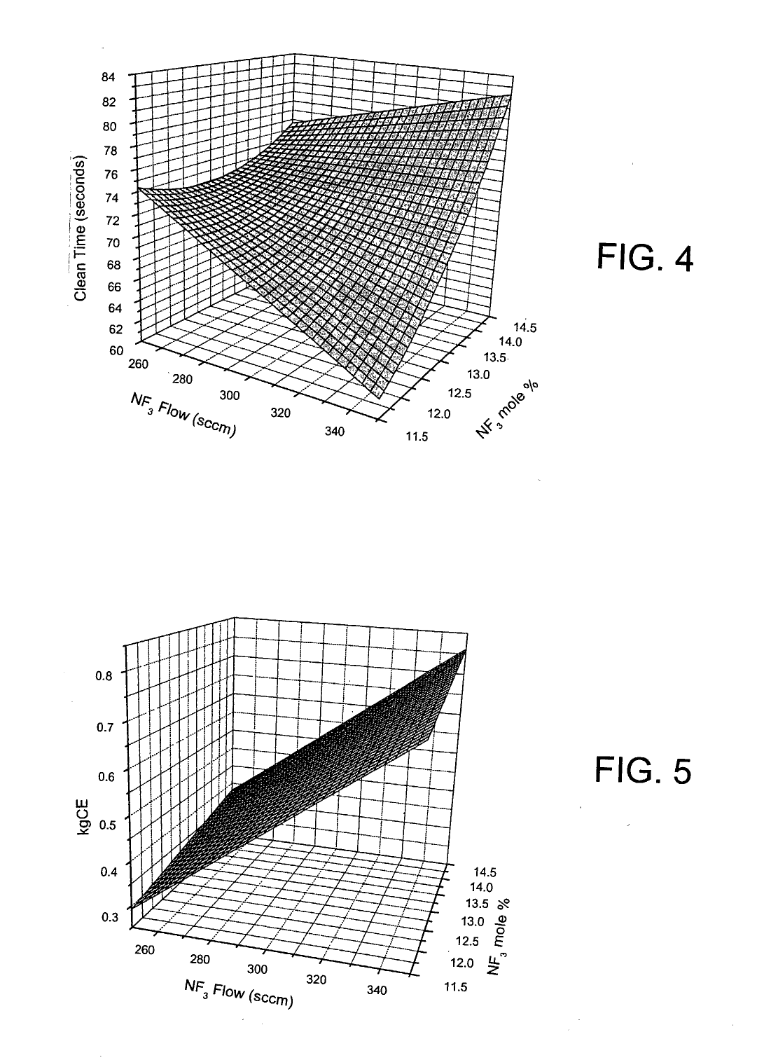

FIG. 4 shows the complex dependence of clean time on NF₃ flow rate and NF₃ mole % within the designed process parameter space when the chamber pressure is held at 3 Torr. At low NF₃ flow rates (e.g., 250 sccm), the clean time has a shallow minimum at about 13 mole % NF₃. At high NF₃ flow rates (e.g., 350 sccm), the clean time monotonically increases with NF₃ mole %. Similarly, at low NF₃ concentration (e.g., 11.5 mole %), clean time decreases as NF₃ flow rate increases. At high NF₃ concentration (e.g., 14.5 mole %), clean time increases as NF₃ flow rate increases. Notably, at intermediate NF₃ concentration (approximately 13 mole %), clean time has little dependence on NF₃ flow rate.

The global warming emissions parameter, kgCE, has a very different dependence as shown in FIG. 5. Increasing NF₃ mole % increases kgCE slightly, but increasing NF₃ flow rate increases kgCE dramatically.

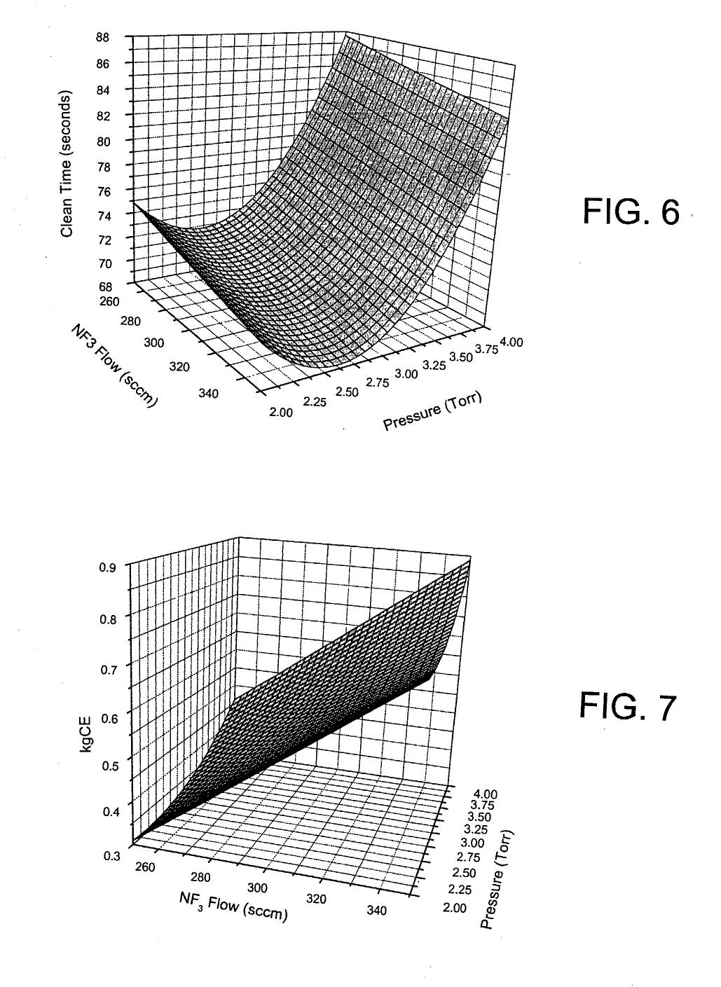

FIG. 6 shows the functional dependence of clean time on NF₃ flow rate and chamber pressure at 13 mole % NF₃. While clean time decreases with increasing NF₃ flow rate, clean time shows a parabolic dependence on chamber pressure. The minimum clean time (i.e., the valley in the response surface) generally occurs around 2.25 to 3.25 Torr pressure range. FIG. 7 shows the dependence of total global warming emissions kgCE on NF₃ flow rate and chamber pressure. Interestingly, the kgCE dependence on pressure is similar to that of clean time, wherein the minimum kgCE generally occurs around 2.25 to 3.25 Torr pressure range.

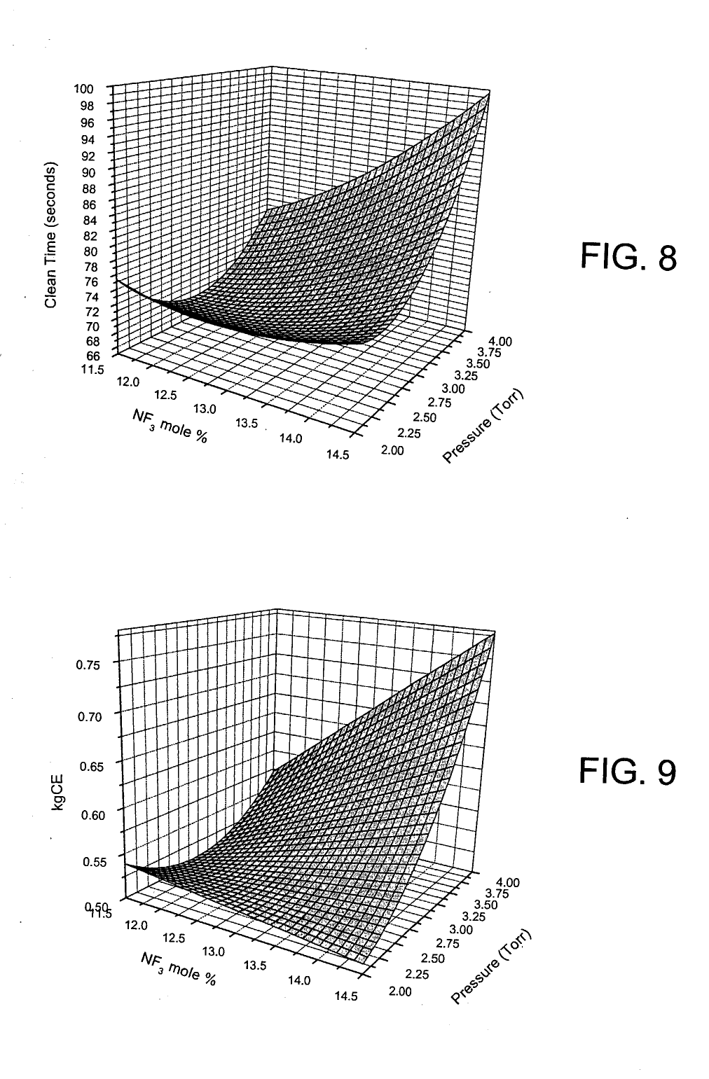

Similar parametric functional dependence is confirmed in FIGS. 8 and 9, where the NF₃ flow rate is fixed at 300 sccm. In FIG. 8, the clean time shows a minimum range at 11.5 to 13 mole % NF₃ mole fraction and 2.25 Torr to 3.25 Torr reactor pressure. Clean time becomes longer with increasing NF₃%, particularly at higher pressure (e.g. 4.0 Torr). In FIG. 9, chamber pressure below 3.25 Torr yields the lowest kgCE. Also, at pressures below 3.25 Torr, kgCE has little dependence on NF₃%. On the other hand, at higher pressures (e.g., 4.0 Torr), kgCE increases dramatically as NF₃% increases.

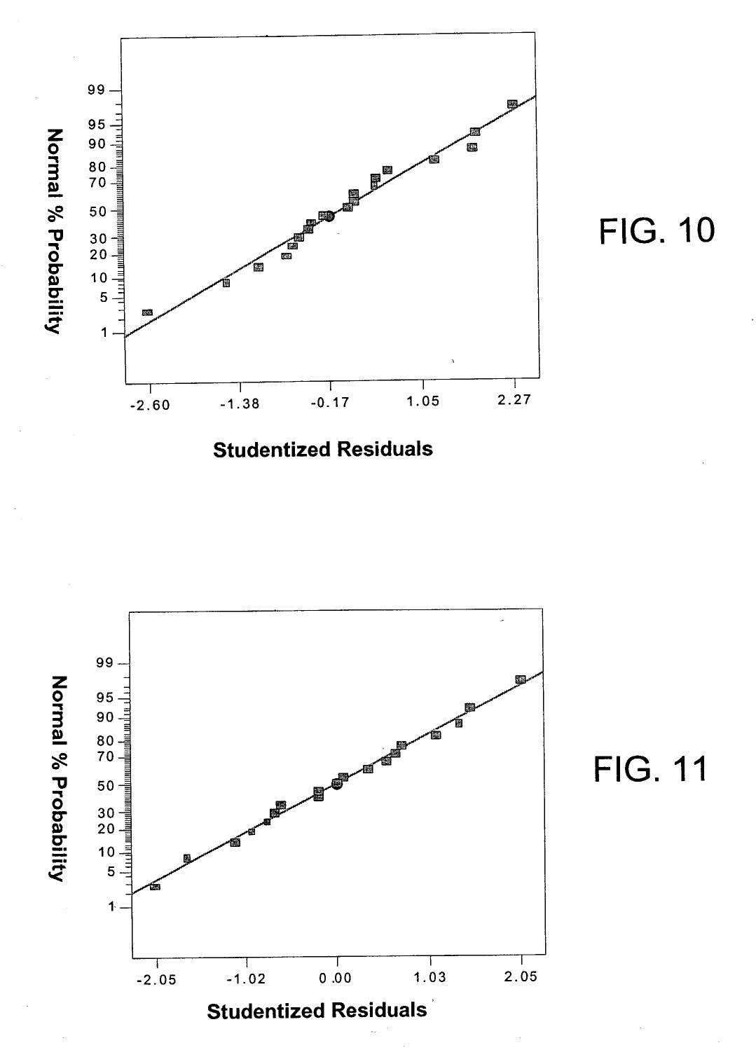

In order to examine the statistical validity of the above response surface models, normal residues of the both the clean time model and the kgCE model are plotted in FIGS. 10 and 11. Excellent linearity was shown in both plots, substantiating the statistical validity of the response surface models. To further verify the models experimentally, seven extra experimental validation runs were performed. Table 2 lists the conditions for these validation runs.

TABLE 2
Experimental Validation Run Conditions

| | | | | | RF Power |
|---|---|---|---|---|---|
| Validation | NF₃ Flow | He Flow | | Pressure | Density |
| Run No. | (sccm) | (sccm) | NF₃ mole % | (Torr) | (W/cm²) |
| 1 | 300 | 1769 | 14.5 | 3.00 | 2.9 |
| 2 | 300 | 1843 | 14.0 | 3.00 | 2.9 |
| 3 | 300 | 1843 | 14.0 | 2.75 | 2.9 |
| 4 | 300 | 1769 | 14.5 | 2.75 | 2.9 |
| 5 | 300 | 2008 | 13.0 | 2.50 | 2.9 |
| 6 | 300 | 1843 | 14.0 | 2.00 | 2.9 |
| 7 | 250 | 1673 | 13.0 | 3.00 | 2.9 |

The measured clean time and kgCE results were then compared with response surface model predicted values. As shown in Table 3, all seven extra runs had excellent agreement with the model predictions—well within the 95% probability intervals (PI).

TABLE 3
Experimental Model Validation
Between Experiments and Predictions

| Vali- | | | | | | |
|---|---|---|---|---|---|---|
| dation | Clean Time, sec | | | Global Warming Emissions | | |
| Run | Mea- | Pre- | | Parameter, kgCE | | |
| No. | sured | dicted | 95% PI | Measured | Predicted | 95% PI |
| 1 | 85 | 79 | 69-90 | 0.54 | 0.60 | 0.47-0.72 |
| 2 | 80 | 76 | 64-86 | 0.59 | 0.58 | 0.46-0.70 |
| 3 | 74 | 74 | 64-84 | 0.47 | 0.56 | 0.44-0.68 |
| 4 | 73 | 77 | 67-87 | 0.47 | 0.57 | 0.44-0.69 |
| 5 | 76 | 70 | 60-80 | 0.53 | 0.53 | 0.41-0.64 |
| 6 | 80 | 74 | 64-85 | 0.55 | 0.51 | 0.39-0.64 |
| 7 | 71 | 75 | 64-86 | 0.29 | 0.31 | 0.18-0.43 |

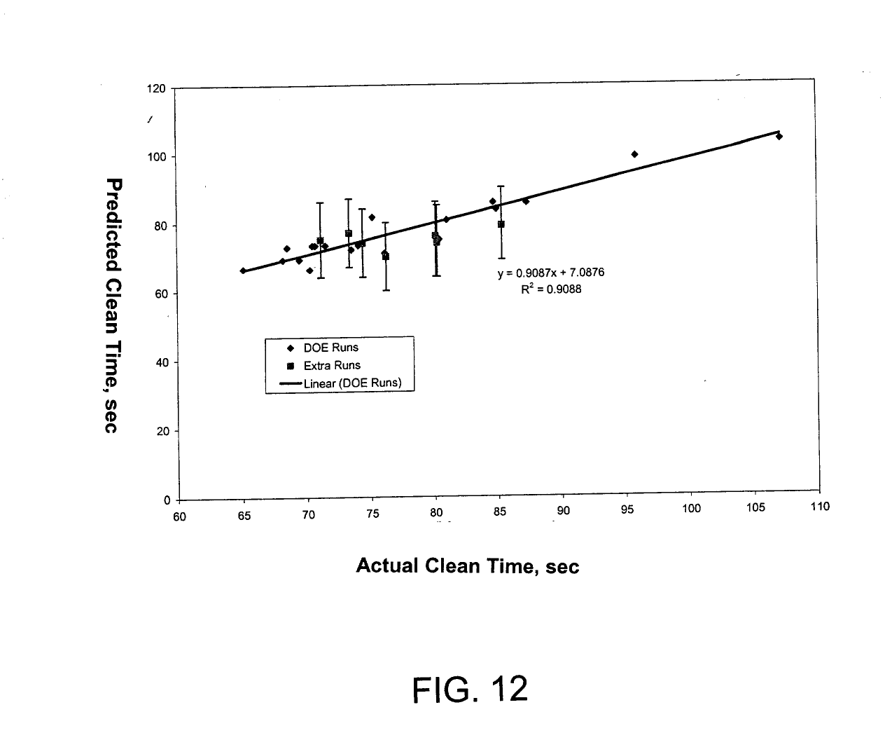

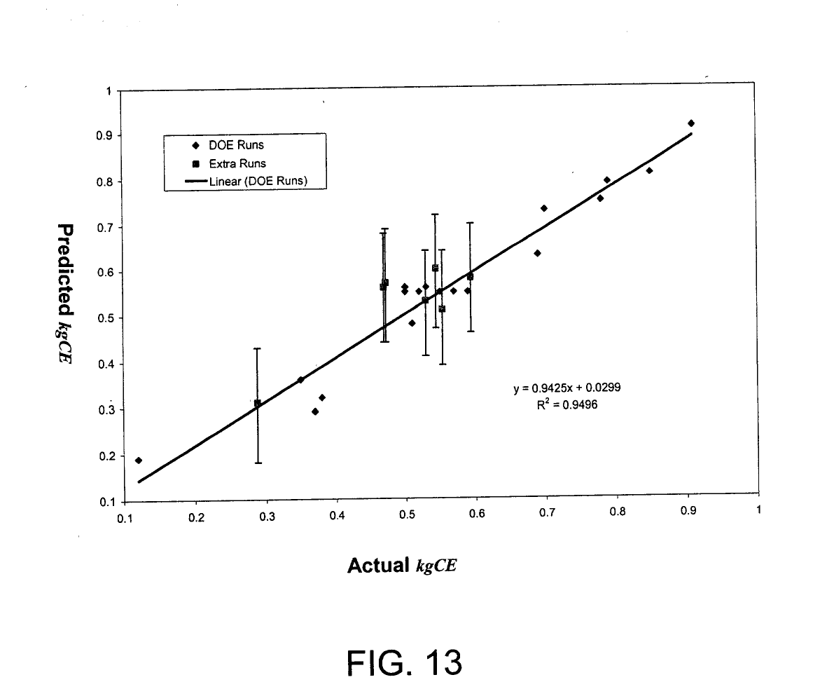

FIGS. 12 and 13 compare the experimental and model predicted clean time and kgCE values from the designed experimental (DOE) runs and the extra validation runs. Linear least squares fits of data points from the designed experimental runs were also plotted. These plots also validate the response surface models for clean time and global warning emissions kgCE.

The above experiments were obtained at 2.9 W/Cm² RF power density, but the power density may be varied. Preferably, the power density is greater than 1.4 W/cm² and a typical operating range may be 2.5 to 3.5 W/cm². Increasing the RF power density can significantly reduce both clean time and kgCE emissions. However, RF power density which is too high enhances sputtering damage of the electrodes and promotes hardware damage. Therefore, a proper balance must be made between superior cleaning performance and long term reactor stability.

Operating NF₃ plasma clean processes at relatively higher pressures (such as 3.0 Torr in the above examples) and at very dilute concentrations (such as 13 mole % in the above examples) helps to reduce sputtering induced damage. Electron temperature and plasma potential decrease with increasing pressure, and power electrode (showerhead) dc self-bias voltage also decreases significantly at pressures above 2.0 Torr. Lower NF₃ concentration leads to lower electronegativity of the plasmas. These electrical and dynamical changes in the plasma reduce the ion energy and fluxes incident upon the showerhead and susceptor surfaces, and hence reduce hardware damage.

After validating the experimentally designed response surface models as described above, the parametric functional relationships in FIGS. 4-9 were examined to facilitate the chamber clean optimization. From the illustrations above, it is apparent that 13 mole % NF₃ concentration and 3.0 Torr chamber pressure offer the most preferred condition (i.e. the sweet spot) to achieve both fast clean (short clean time) and low global warming emission (low kgCE). To optimize NF₃ flow rate, tradeoffs must be made between competing dependencies of clean time and kgCE. An overall optimized flow rate of 300 sccm NF₃ flow offers the best balance between clean time and kgCE emissions. However, depending on optimization priorities, either a slightly higher NF₃ flow rate for faster clean time, or a slightly lower NF₃ flow rate for lower kgCE, may be selected.

Table 4 lists some of the preferred embodiments of the present invention. For comparative reference, an Applied Materials standard (BKM) C₂F₆ clean was also performed on the same CVD chamber. Table 5 lists the C₂F₆ BKM recipe and cleaning performance. The clean time and the kgCE values in Table 5 are averages of eight repeated measurements randomly interleaved among the NF₃ optimization runs. The experimentally measured optimized dilute NF₃ chamber cleaning results and comparisons with C₂F₆ BKM data are shown in Table 6.

TABLE 4
Optimized Dilute NF₃ Clean Recipes

| | | | | | RF Power |
|---|---|---|---|---|---|
| | NF₃ Flow | He Flow | | Pressure | Density |
| Recipe | (sccm) | (sccm) | NF₃ mole % | (Torr) | (W/cm²) |
| Balanced | 300 | 2008 | 13 | 3.0 | 2.9 |
| Faster | 384 | 2570 | 13 | 3.0 | 2.9 |
| Lower | 250 | 1673 | 13 | 3.0 | 2.9 |
| Emission | | | | | |
| Lowest | 216 | 1445 | 13 | 3.0 | 2.9 |
| Emission | | | | | |

TABLE 5
Standard C₂ F₆ BKM Recipe and Results

| | | | | | | | C₂F₆ |
|---|---|---|---|---|---|---|---|
| | O₂ | | RF Power | Clean | | Clean | Destruction |
| C₂F₆ Flow | Flow | Press. | Density | Time ± 1σ | | Gas Usage | Efficiency ± |
| (sccm) | (sccm) | (Torr) | (W/cm²) | (seconds) | kgCE ± 1σ | (pounds) | 1σ (%) |
| 600 | 600 | 4 | 2.9 | 83 ± 3 | 12.72 ± 0.45 | 0.011 | 35.84 ± 1.35 |

TABLE 6
Optimized Dilute NF₃ Clean Results
and Comparison with C₂F₆ BKM

| | | | Carbon Equivalent | | Clean Gas | | |
|---|---|---|---|---|---|---|---|
| | CleanTime | | Emissions(kgCE) | | Usage | | |
| | NF₃ | | | | NF₃ | | NF₃ |
| | Clean | | NF₃ | | Reactor | | Destruction |
| | Time ± | Relative | Reactor | Relative | Feed | Relative | Efficiency ± |
| | 1σ | to C₂F₆ | Emissions ± | to C₂F₆ | Gas | to C₂F₆ | 1σ |
| Recipe | (sec) | BKM | 1 σ (Kg) | BKM | (lb) | BKM | (%) |
| Balanced | 71 ± 2 | −15(%) | 0.54 ± 0.03 | −96(%) | 0.0025 | −78(%) | 85.91 ± 1.15 |
| Faster | 70 | −15(%) | 0.91 | −93(%) | 0.0031 | −72(%) | 78.64 |
| Lower | 71 | −14(%) | 0.29 | −98(%) | 0.0021 | −82(%) | 93.94 |
| Emission | | | | | | | |
| Lowest | 74 | −11(%) | 0.12 | −99(%) | 0.0018 | −84(%) | 99.24 |
| Emission | | | | | | | |

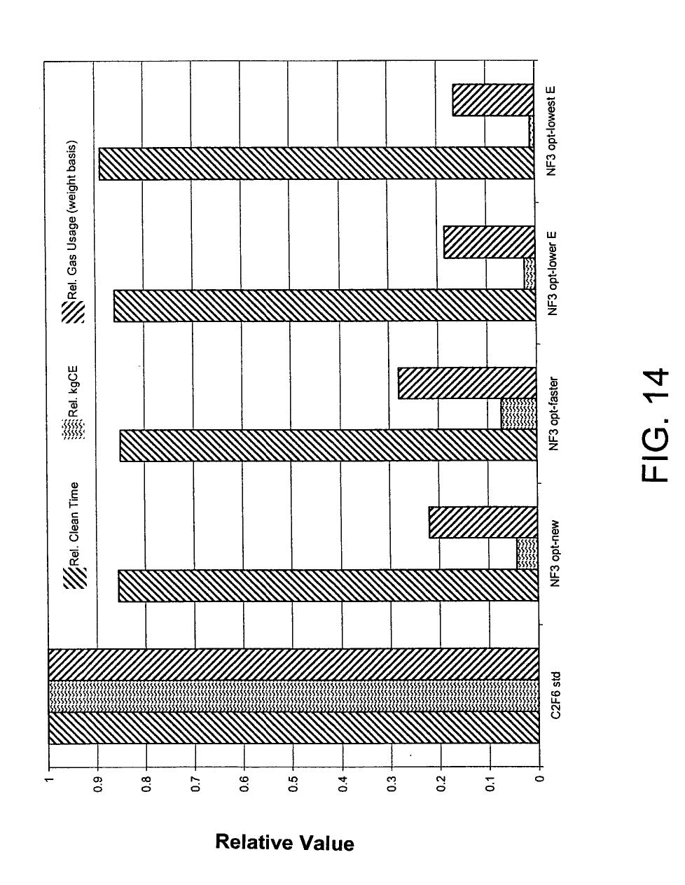

FIG. 14 shows the relative comparison between the standard C₂F₆ BKM clean and the several optimized dilute NF₃ cleans listed in Tables 4 and 6. It can be seen that all of the optimized dilute NF₃ cleans yield faster clean time, greatly reduced global warming emissions, and use significantly less cleaning gas (on a weight basis). In particular, the “Lowest Emission” recipe achieves nearly complete (99.24%) destruction of NF₃ in the plasma. As a result, it offers 99% reduction of global warming emissions. This dramatic reduction in global warming emissions is accomplished with an 11% reduction in clean time and an 84% reduction in clean gas usage at the same time.

Helium is one of the most efficient coolant gases for carrying away excessive heat from hot surfaces and the cooling efficiency increases at higher pressures. The high flow rate of helium diluent and the relatively higher pressures (2.0-3.5 Torr) utilized in the present invention prevent the susceptor and showerhead surfaces from overheating. Fluorocarbons and oxygen are not effective coolant gases. As a result, the susceptor and showerhead can become overheated, particularly at higher RF power densities (such as 3 W/cm² or higher.) In a production platform, susceptor over-temperature triggers automatic process shutdown, causing productivity and yield loss. Moreover, overheating of reactor interior surfaces accelerates reactor component degradation, which is a major aspect of hardware damage. Therefore, the effective cooling from high helium flow not only improves productivity and yield, but also alleviates hardware degradation. While helium is a preferred diluent, other pure component or mixed diluent gases may be used in the method of the present invention. For example, the diluent gas may comprise one or more components selected from the group consisting of helium, argon, nitrogen, nitrous oxide, oxygen, neon, krypton, and xenon.

The process of the present invention using dilute NF₃ plasmas may be operated in a reactor or processing chamber pressure range of greater than 1.0 and less than about 10 Torr, and the pressure may be varied during the clean time as desired. One preferred operating range is 2.0 to 3.5 Torr, wherein the pressure during the clean time is essentially constant, i.e., does not vary by more than about ±10% during the clean time. Alternatively, the reactor pressure may be varied during the cleaning process. For example, the cleaning may be initiated in a higher pressure range of between about 3 and about 10 Torr. As the cleaning progresses, the pressure may be decreased to a lower pressure range of between about 1 and about 4 Torr.

In one embodiment of the invention, NF₃ may be utilized as a sole cleaning reactant in the cleaning gas mixture. In other embodiments, the cleaning gas mixture may utilize an additional reactant or reactants in combination with NF₃ such as, for example, F₂, CF₄, and/or C₂F₆. In at least one embodiment in which an additional reactant or reactants are used with NF₃, the additional reactant or reactants may exclude any chlorine-containing reactants.

While the method of the present invention is illustrated in the exemplary process described above for cleaning CVD chambers with PE-TEOS deposited material, i.e., SiO₂ films, the same principles and operating conditions can be applied to any other type of deposited material in any other type of process or process chamber in which the deposited material can be reacted with and volatilized by fluorine-containing active reactants. For example, the present invention may be applied to deposited materials which include, but are not limited to, the following: conductor films, such as tungsten; tungsten silicide; semiconductor films such as undoped and doped poly-crystaline silicon (poly-Si), doped and undoped (intrinsic) amorphous silicon (a-Si); dielectric films such as silicon dioxide (SiO₂), undoped silicon glass (USG), boron doped silicon glass (BSG), phosphorous doped silicon glass (PSG), and borophosphorosilicate glass (BPSG), silicon nitride (Si₃N₄), silicon oxynitride (SiON) etc.; low-k dielectric films such as fluorine doped silicate glass (FSG), and carbon doped silicon glass, such as “Black Diamond”. In all these applications, atomic fluorine (F.) is the primary reactive agent for cleaning. Judiciously chosen dilute NF₃ in situ plasma operating parameters is the key for effective generation and utilization of atomic fluorine (F.). Therefore the same optimization methodology and preferred embodiments can provide similar optimal chamber cleaning performance.

The term “processing chamber” as used herein means (a) any reactor in which material is deposited on articles placed therein and also is deposited on the interior surfaces of the reactor and (b) any reactor in which material is removed from articles placed therein as volatile reaction products wherein some of the reaction products cause material to deposit on the interior surfaces of the reactor. The term “deposited material” means any element or compound which is deposited on the interior surfaces of a processing chamber by the processes utilized in (a) and (b) described above.

The invention is illustrated in the exemplary process described above using a specific type of deposition reactor. However, the methodology of the invention also can be applied to other types of deposition reactors and to other types of processing chambers that may include, but are not limited to, chemical vapor deposition (CVD) chambers, subatmospheric pressure chemical vapor deposition (SACVD) chambers, sputtering deposition chambers, and etching chambers.

The careful choice of operating conditions using a plasma feed gas containing less than 15 mole % NF₃ and a RF power density of greater than 1.4 W/cm² to generate the plasma will allow the optimization of the dilute NF₃ in situ chamber clean process to achieve the objectives stated above. Chamber pressures of greater than 1.0 and less than about 10 Torr may be used. The flow rate of the NF₃ portion of the gas mixture introduced into the processing chamber may be greater than 200 sccm. The application of this invention allows optimization of the NF₃ chamber clean process to yield optimal combinations of clean time, NF₃ consumption, global warming emissions, and reactor hardware integrity.

1. A method for removing deposited material from the interior surfaces of a processing chamber comprising:
(a) introducing a gas mixture comprising less than 15 mole % nitrogen trifluoride in a diluent gas into a processing chamber having deposited material on the internal surfaces thereof;
(b) establishing a plasma in the processing chamber utilizing a radio frequency power density of greater than 1.4 W/cm and forming chemically reactive fluorine-containing species therein;
(c) reacting the deposited material with the chemically reactive fluorine-containing species to yield volatile reaction products; and
(d) removing the volatile reaction products from the processing chamber.

2. The method of claim 1 wherein the diluent gas comprises one or more components selected from the group consisting of helium, argon, nitrogen, nitrous oxide, oxygen, neon, krypton, and xenon.

3. The method of claim 2 wherein the diluent gas is helium.

4. The method of claim 1 wherein the gas mixture contains greater than 10 mole % and less than 15 mole % nitrogen trifluoride.

5. The method of claim 1 wherein the flow rate of the nitrogen trifluoride portion of the gas mixture introduced into the processing chamber is greater than 200 sccm.

6. The method of claim 1 wherein the pressure in the processing chamber at any time during (a) through (d) is greater than about 1 and less than about 10 Torr.

7. The method of claim 6 wherein the pressure in the processing chamber at any time during (a) through (d) is between about 3 and about 10 Torr

8. The method of claim 6 wherein the pressure in the processing chamber at any time during (a) through (d) is between about 1 and about 4 Torr.

9. The method of claim 6 wherein the pressure in the processing chamber is essentially constant during (a) through (d) at a pressure between about 2.0 and about 3.5 Torr.

10. The method of claim 1 wherein the radio frequency power density is between about 2.3 and about 3.5 W/cm².

12. A method for removing deposited material from the interior surfaces of a processing chamber comprising:
(a) introducing a gas mixture comprising greater than 10 mole % and less than 15 mole % nitrogen into a processing chamber having deposited material on the internal surfaces thereof;
(b) establishing a plasma in the processing chamber utilizing a radio frequency power density of 2.3 to 3.5 W/cm² and forming chemically reactive fluorine-containing species therein;
(c) reacting the deposited material with the chemically reactive fluorine-containing species at a pressure between about 2.0 and about 3.5 Torr to yield volatile reaction products; and
(d) removing the volatile reaction products from the processing chamber.

13. The method of claim 12 wherein the flow rate of the nitrogen trifluoride introduced into the processing chamber is greater than 200 sccm.

14. The method of claim 12 wherein the diluent gas comprises one or more components selected from the group consisting of helium, argon, nitrogen, nitrous oxide, oxygen, neon, krypton, and xenon.

15. The method of claim 14 wherein the diluent gas is helium.

16. The method of claim 14 wherein the diluent gas is helium and the flow rate of the nitrogen trifluoride introduced into the processing chamber is greater than 200 sccm.
